(19) United States
(12) Patent Application Publication
(10) Pub. No.: US 2007/0050474 A1
(43) Pub. Date: Mar. 1, 2007

(54) System, method and apparatus for downloading data

(75) Inventors: Cheng-Shing Lai, Taipei (TW); Xiaobo Shu, Nanking City (CN)

Correspondence Address: BIRCH STEWART KOLASCH & BIRCH, PO BOX 747, FALLS CHURCH, VA, 22040-0747, US

(73) Assignee: Inventec Appliances Corp.

(21) Appl. No.: 11/511,458

(22) Filed: Aug. 29, 2006

(30) Foreign Application Priority Data
Aug. 29, 2005 (TW) 94129556

(51) Int. Cl. G06F 15/16

(52) U.S. Cl. 709/217

(57) ABSTRACT

A downloading system includes a computing device for providing a configuring data, a downloading apparatus coupled electrically to the computing device for conducting downloading operation according to the configuring data in order to download the data via the Internet, and a storage unit coupled electrically to the downloading apparatus for storing the data.

### FIELD OF THE INVENTION

The invention relates to a downloading system, method and apparatus thereof, and more particularly to the downloading system for use in a computer system and the downloading method and the downloading apparatus.

### BACKGROUND OF THE INVENTION

The prevalence of PCs (personal computers) and since the Internet Service Providers offer cheap service charges for connection to the Internet, the majority of PCs are connected to the Internet and serve as the data exchanging tools for the users. Therefore, there is a rapid increase of the Internet connected PCs. For instance, it is very common that the PC can download software, music, movie and even a text via the Internet.

In the prior art, during downloading of music, TV games and movies via the Internet, the hard disk of the computer system must undergo an extremely large numbers of reading and writing operations, thereby occupying a relatively large space of the hard disk, which, in turn, lowers the execution speed of the computer system. The downloading operation may take a considerable long time while the computer system generates disturbing noise and thus results in power waste and radiation.

In view of the aforesaid disadvantages, the computer manufacturers have devoted themselves in researches to find a downloading system, method and apparatus that can be free from those disadvantages encountered during the downloading operation.

### SUMMARY OF THE INVENTION

Therefore, it is the object of the present invention to provide a downloading system, method and apparatus thereof such that the downloading system can effectively conduct the downloading operation and the downloading speed is not affected by the downloading operation.

In one aspect of the present invention, a downloading system is provided for downloading data. The downloading system includes a computing device for providing configuring data which includes a default condition set according to specific downloading requirement, a downloading apparatus coupled electrically to the computing device for conducting downloading operation according to the configuring data in order to download the data via the Internet, and a storage unit coupled electrically to the downloading apparatus for storing the data.

In a second aspect of the present invention, a method is provided for downloading data. The downloading method includes the steps: (a) configuring a computing device so that the computing device is capable of providing configuring data which includes a default condition for performing predetermined functions; (b) configuring a downloading apparatus for conducting downloading operation according to the configuring data in order to download the data via the Internet, the downloading apparatus being coupled electrically to the computing device; and (c) configuring a storage unit for storing the data, the storage unit being coupled electrically to the downloading apparatus.

In a third aspect of the present invention, a downloading apparatus is provided for electrically coupling a computing device and a storage unit. The downloading apparatus includes a control unit for receiving configuring data from the computing device, a temporary storage unit for temporarily storing the configuring data, an operation interface for receiving a download command, and a transmission interface for connecting to the Internet. The control unit downloads a piece of data according to the download command and the configuring data via the Internet in order to store the data within the storage unit.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a functional block diagram illustrating a downloading system of the present invention;

FIG. 2 is a flowchart illustrating the steps in a downloading method of the present invention;

FIG. 3 is a functional block diagram illustrating a downloading apparatus of the present invention;

FIG. 4 illustrates default conditions of a control unit employed in the downloading apparatus of the present invention;

FIG. 5 illustrates the steps for shutting the downloading apparatus of the present invention;

FIG. 6 illustrates the block diagram for conducting a specific process by the downloading apparatus of the present invention; and

FIG. 7 shows a network card employed in the downloading apparatus of the present invention.

### DETAILED DESCRIPTIONS OF THE PREFERRED EMBODIMENTS

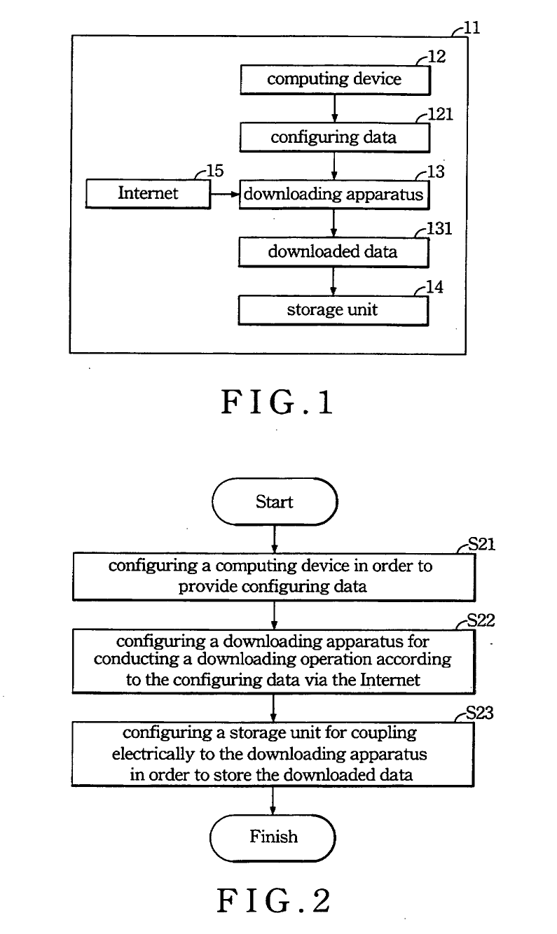

FIG. 1 shows a downloading system 11 of the present invention for downloading data. The downloading system 11 accordingly includes a computing device 12, a downloading apparatus 13 and a storage unit 14. The computing device 12 provides a configuring data 121 having an IP address. The downloading apparatus 13 is coupled electrically to the computing device 12 for conducting downloading operation according to the IP address in order to download the data via the Internet 15. The storage unit 14 can be a hard disk or whatever data can be stored there within. The storage unit 14 is coupled electrically to the downloading apparatus 13 for storing the downloaded data 131 upon finishing of the downloading operation. In addition, the computing device 12 is capable of supplying the configuring data 121 to the downloading system 11 in advance such that the downloading operation can still be conducted by the downloading system 11 even though the computing device 12 is shut down already.

FIG. 2 is a flowchart illustrating the steps in the downloading method according to the present invention for downloading the data. The downloading method includes the steps: (S21) configuring a computing device so that the computing device is capable of providing configuring data which includes a default condition for performing predetermined functions; (S22) configuring a downloading apparatus for conducting downloading operation according to the configuring data in order to download the data via the Internet, the downloading apparatus being coupled electrically to the computing device; and (S23) configuring a storage unit for storing the data, the storage unit being coupled electrically to the downloading apparatus. The method further includes the steps: providing at least one hard disk for serving as the storage unit and providing at least one IP address for serving as the configuring data.

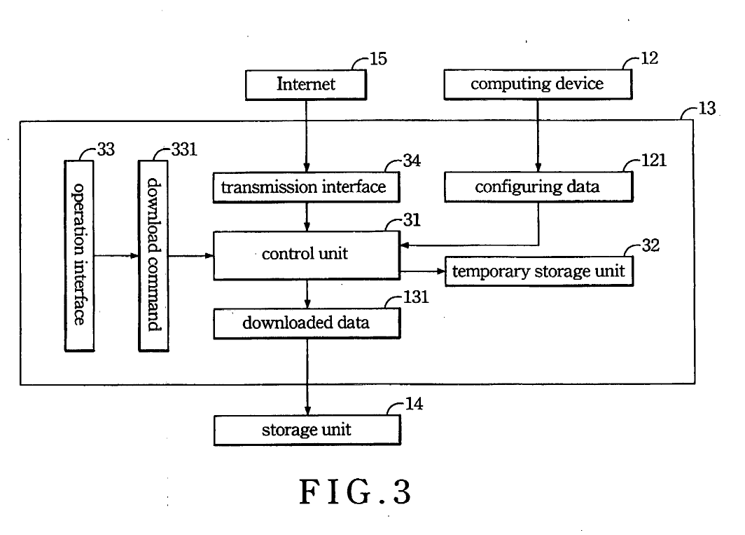

FIG. 3 is a functional block illustrating a downloading apparatus 13 of the present invention. The downloading apparatus 13 is electrically coupled to the computing device 12 and the storage unit 14, and includes a control unit 31, a temporary storage unit 32, an operation interface 33 and a transmission interface 34. The control unit 31 receives configuring data 121 from the computing device 12. The configuring data 121 can have an IP address. The temporary storage unit 32 can be a RAM (Random Access Memory) for temporarily storing the IP address 121. The operation interface 33 is used for receiving a download command 331 while the transmission interface 34 is used for coupling the downloading apparatus 13 to the Internet 15. Upon receipt of the download command 331, the control unit 31 downloads the data 131 according to the IP address via the Internet 15 and later stores the downloaded data 131 within the storage unit 14. In addition, the control unit 31 further includes two types of conditions, namely default conditions 41 and monitoring functions. The control unit 31 is adapted to conduct a shutting operation upon receipt of a shutting signal. The default conditions 41 are setup depending on several conditions or limitations 44 for use in the downloading apparatus 13. The monitoring functions can be preset in such that the downloading operation can be monitored, for example, in case an error occurred during the downloading operation of the data, the error is recorded within the temporary storage unit 34. The downloading apparatus 13 can be a connection tool for connecting to the Internet, such as a network card or a device for executing a specific process.

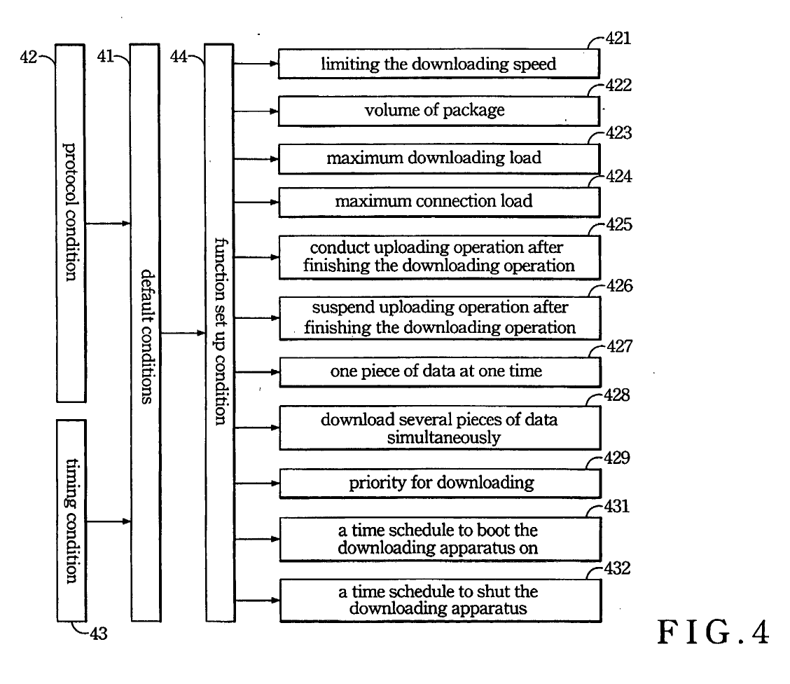

FIG. 4 illustrates the default conditions 41 of the control unit employed in the downloading system of the present invention. The default conditions 41 are classified into two sets of conditions 44 depending on the communication protocol condition 42 and the timing condition 43. When the default condition 41 is setup based on the communication protocol condition 42, the first set of condition 44 may include (a) limiting the downloading speed 421, (b) volume of package 422 for downloading, (c) maximum downloading load 423, (d) maximum connection load 424, (e) conduct uploading operation 425 after finishing the downloading operation, (f) suspend uploading operation 426 after finishing the downloading operation, (g) download one piece of data 427 at one time, (h) download several pieces of data simultaneously and limiting the number of data 428, and (i) priority of downloading 429. When the default condition 41 is setup based on the timing condition 43, the second set of condition 44 may include (a) a time schedule 431 for automatically booting the downloading apparatus, and (b) a time schedule 432 for automatically shutting the downloading apparatus. In addition, the communication protocol condition 42 may be a FTP (File Transfer Protocol), HTTP (Hyper Text Transfer Protocol) or P2P (Point To Point). The control unit executes the booting or shutting operation via a booting or shutting command.

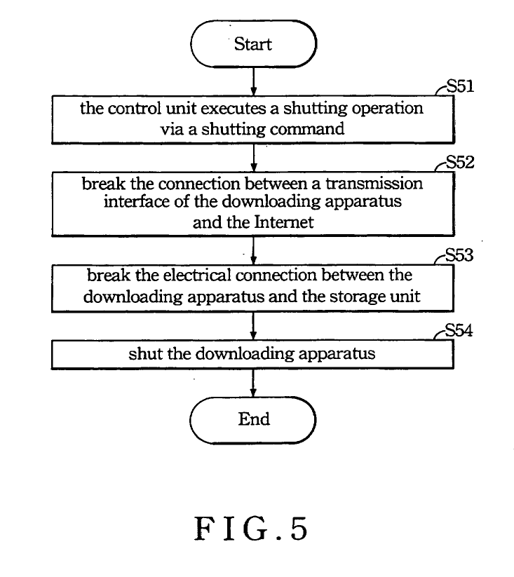

FIG. 5 illustrates the steps for shutting the downloading apparatus of the present invention. According to the step (S51), the control unit of the downloading apparatus executes a shutting operation via a shutting command. In the step (S52), the connection between the transmission interface of the downloading apparatus and the Internet is broken. In the step (S53), the electrical connection between the downloading apparatus is broken. Finally, the downloading apparatus is shut down in step (S54). The shutting command is generated under the following conditions, (1) once the control unit recognizes a finishing signal for the downloading operation of the data based on the download command, (2) once the control unit recognizes a time schedule for shutting the downloading apparatus, (3) once the control unit receives a shutting signal of the transmission interface, (4) once the control unit receives an attack signal of the transmission interface (indicating that the transmission interface being attached by the Internet), (5) once the control unit receives a storage signal indicating insufficient storage space in the storage unit, and (6) once the control unit receives a damage signal indicating ruin of the storage unit. In addition, the shutting command is generated once the control unit receives a shutting signal of the transmission interface.

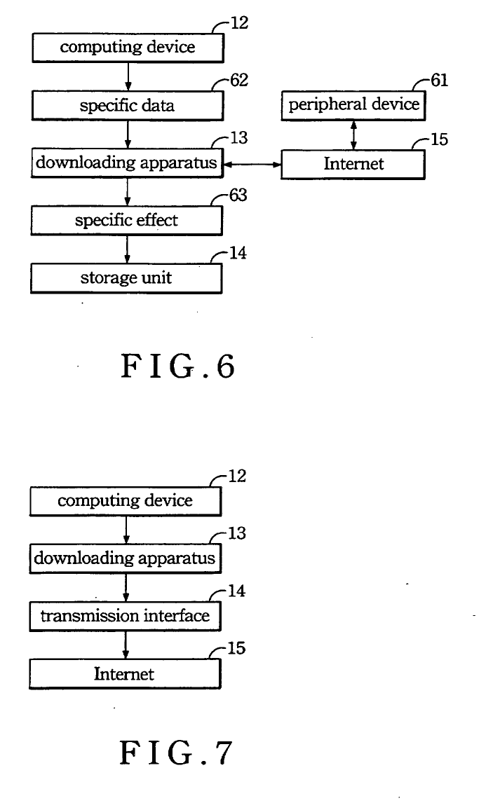

FIG. 6 illustrates the block diagram for conducting a specific procedure (such as to monitor a system function online) by the downloading apparatus of the present invention. Firstly, the computing device 12 provides a specific data 62 (such as monitoring data) to the downloading apparatus 13 in advance. Under this condition, the downloading apparatus 13 is capable of monitoring a peripheral device 61 in accordance with the specific data 62 via the Internet 15 so as to result in a specific effect 63 (such as monitor effect). Finally, the specific effect 63 is stored within the storage unit 14.

FIG. 7 shows one embodiment of a network card of the present invention, wherein the downloading apparatus 13 serves as the network card in order to download a piece of data. As illustrated, the computing device 12 is coupled electrically to the downloading apparatus 13, which, in turn, is coupled to the Internet 15 via a transmission interface 34.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A downloading system for downloading data, comprising:
a computing device for providing a configuring data, said configuring data including a default condition set according to specific downloading requirements;
a downloading apparatus coupled electrically to said computing device for conducting downloading operation according to said default condition of said configuring data in order to download the data via the Internet; and
a storage unit coupled electrically to said downloading apparatus for storing the data.

2. The downloading system according to claim 1, wherein said storage unit is a hard disk.

3. The downloading system according to claim 1, wherein said configuring data is provided in advance by said computing device.

4. The downloading system according to claim 1, wherein said configuring data comprises an IP (Internet Protocol) address.

5. A method for downloading data, comprising:
(a) configuring a computing device so that said computing device is capable of providing a configuring data, said configuring data including a default condition for performing predetermined functions;
(b) configuring a downloading apparatus for conducting downloading operation according to said default condition of said configuring data in order to download the data via the Internet, said downloading apparatus being coupled electrically to said computing device; and
(c) configuring a storage unit for storing the data, said storage unit being coupled electrically to said downloading apparatus.

6. The downloading method according to claim 5, further comprising a step (d) providing at least one hard disk for serving as said storage unit.

7. The downloading method according to claim 5, wherein said configuring data is provided in advance by said computing device.

8. The downloading method according to claim 5, further comprising a step (e) providing at least one IP address serving as said configuring data.

9. A downloading apparatus for electrically coupling a computing device and a storage unit, comprising:
a control unit for receiving a configuring data from the computing device;
a temporary storage unit for temporarily storing said configuring data;
an operation interface for receiving a download command; and
a transmission interface for connecting to the Internet;
wherein, said control unit downloads a piece of data according to said download command and said configuring data via the Internet in order to store said data within the storage unit.

10. The downloading apparatus according to claim 9, wherein said control unit includes a preset function for setting up a default condition.

11. The downloading apparatus according to claim 10, wherein said default condition is setup according to a communication protocol condition.

12. The downloading apparatus according to claim 10, wherein said default condition is setup according to a timing condition.

13. The downloading apparatus according to claim 10, wherein said default condition is a maximum downloading or uploading speed of said data.

14. The downloading apparatus according to claim 10, wherein said default condition is a maximum connection load.

15. The downloading apparatus according to claim 10, wherein said default condition is to conduct or suspend an uploading operation after finishing said downloading operation.

16. The downloading apparatus according to claim 10, wherein said default condition is a priority for downloading.

17. The downloading apparatus according to claim 10, wherein said default condition is a time schedule for automatically booting or shutting the downloading apparatus.

18. The downloading apparatus according to claim 9, wherein said control unit executes a shutting operation via a shutting command which is generated once said control unit recognizes a finishing signal for finishing a downloading operation of the data, recognizes a time schedule for shutting the downloading apparatus, receives a shutting signal of said transmission interface, receives an attack signal of said transmission interface, receives a storage signal indicating insufficient storage space in said storage unit, or receives a damage signal indicating ruin of said storage unit.

19. The downloading apparatus according to claim 18, wherein said shutting operation is to break off the communication between said transmission interface and the Internet, and between the computing device and said hard disk.

20. The downloading apparatus according to claim 9, wherein said control unit includes a monitor function for monitoring downloading operation of the data such that an error encountered during said downloading operation is recorded within said temporary storage unit.
